(19) United States
(12) Patent Application Publication
(10) Pub. No.: US 2009/0208660 A1
(43) Pub. Date: Aug. 20, 2009

(54) METHOD FOR CONTROLLING ONSET OF FOG WHEN COATING FLEXIBLE SUPPORTS WITH A LIQUID SILICONE COMPOSITION, IN A CYLINDER-TYPE DEVICE

(75) Inventors: Nathalie Guennouni, Irigny (FR); Tania Ireland, Lyon (FR); Lucile Gambut-Garel, Lyon (FR); Etienne Fleury, Irigny (FR); Didier Dhaler, Tassin (FR)

Correspondence Address: Baker Donelson Bearman, Caldwell & Berkowitz, PC, 555 Eleventh Street, NW, Sixth Floor, Washington, DC, 20004, US

(73) Assignee: Bluestar Silicones France, Lyon Cedex 03 (FR)

(21) Appl. No.: 12/096,173

(22) PCT Filed: Dec. 8, 2006
(86) PCT No.: PCT/EP2006/069465

§ 371 Date: Jan. 23, 2009

(30) Foreign Application Priority Data
Dec. 9, 2005 (FR) 0512509

(51) Int. Cl. C07F 7/18; B05D 1/28; C08L 83/06

(52) U.S. Cl. 427/428.01; 556/443; 524/861

(57) ABSTRACT

The invention concerns the general field of high speed silicone coating on various flexible cylinders, such as paper or synthetic polymer (polyolefin, polyester), or textile sheets. The invention concerns an efficient method for controlling the onset of fog when coating flexible supports with a liquid silicone composition precursor of crosslinked coatings, said coating being performed using a cylinder-type coating device operating at a high speed.

The invention relates to the general field of the silicone coating, on high-speed rolls, of various flexible supports, such as sheets of paper or of synthetic polymer (polyolefin, polyester, etc), or else of textile.

More specifically the invention concerns the coating of flexible materials with liquid compositions comprising one or more polyorganosiloxanes crosslinkable by polyaddition, by dehydrocondensation, by polycondensation, cationically or free-radically to form a protective coating or film having, in particular, release and/or water repellency properties.

The flexible supports may be papers, cards, plastic films or metallic films. The applications of these silicone-coated supports are, for example: paper for food use (baking molds, wrapping), adhesive label/tape, packing and sealing material, etc.

The coating of these flexible supports with crosslinkable liquid silicones is carried out on coating devices which operate continuously and at very high speed. These devices comprise coating heads composed of a number of rolls, including in particular a press roll and a coating roll, which is fed continuously with crosslinkable liquid silicone composition, by means of a series of rolls which are associated with one another. The web of flexible support circulates at high speed between the press roll and the coating roll and is thereby coated on at least one of its faces with a silicone film which is intended to be crosslinked by crosslinking means disposed downstream of the coating head. These crosslinking means may be emitters of heat, of radiation (e.g., ultraviolet) or of electron beams, for example.

In the race for productivity, the producers of silicone release-coated flexible supports are customers for liquid silicone coating formulations which are suited to increasingly high linear running speeds of the flexible support web. The economic factor is obviously not insignificant in this search for new silicone formulations for high-speed coating.

Nevertheless, the high speeds on continuous coating machines are known to be a byword for problems of transfer of the liquid silicone film from the coating roll to the moving flexible support web. These transfer problems (“splitting”) are manifested, in particular, in the incidence of a mist or aerosol (“misting”, “fogging”) in the area around the coating head and, more particularly, at the points of contact between the rotating rolls and/or between the coating roll and the flexible support to be coated. The density of this mist or of this aerosol increases in line with the linear running speed and hence the speed of rotation of the rolls.

Consequences of this phenomenon are, first of all, a loss of consumable material, and in particular the deposition of droplets of coating liquid on the support downstream (for example, at the oven), which is seriously detrimental to the quality of the coating.

Moreover, this undesirable formation of mist has adverse consequences from the standpoints of industrial hygiene and of safety for the operatives, who are exposed to a high level of aerosol in the vicinity of the roll coating device. This aerosol may be toxic.

Furthermore, the misting gives rise to the rapid fouling of the roll coating device, causing maintenance constraints and premature wear.

To guard against the consequences of this mist, it is usual to dispose a suction withdrawal system around the coating head, allowing said mist to be captured.

Moreover, the skilled worker knows of a certain number of adjustments to the coating head in order to obviate this phenomenon. Some examples of this include:
A. lowering the speed, which is detrimental to productivity;
B. reducing the silicone deposition rate, which is detrimental to the properties of the flexible silicone support it is desired to obtain (appearance, covering, release, mechanical properties);
C. increasing the difference between the tangential speed of the coating roll and the linear speed of the paper; however, beyond a certain differential, the homogeneity of the coating layer is severely disturbed; moreover, it is possible by this means to reduce the density of the mist without eliminating it sufficiently to allow a significant increase in coating speed;
D. increasing the pressure between the coating roll and the press roll; here again, to a certain limit, and without advantageous suppression of the phenomenon of mist formation.

Another approach for controlling the formation of mist in roll coating machines involves acting on the formulation of the liquid silicone coating composition.

In accordance with this approach, it is known to reduce the number-average degree of polymerization of the polyorganosiloxanes forming the silicone coating liquid and, consequently, to reduce the viscosity of the silicone coating bath so as to limit the density of the mist.

These known techniques are subject to a serious drawback, in that they substantially modify the properties and, in particular, the release of the flexible silicone-treated support it is desired to obtain.

To illustrate this approach, through the silicone formulation, it is possible to cite international patent application WO 2004/046248, which describes the use of star-branched silicone polymers used as an antimisting additive for coating applications on flexible supports. The process for preparing these star-branched silicone polymers comprises incompletely reacting (by hydrosilylation) a polyorganosiloxane containing reactive ≡SiH units with a long-chain olefin to give a partially substituted polyhydroorganosiloxane, which is subsequently reacted by hydrosilylation with a vinyl silicone resin of MQ type and a long-chain diolefin. It is clear that compositions of this kind are relatively complex and therefore costly to obtain. Moreover, they still remain capable of improvement in terms of controlling misting in high-speed silicone roll coating.

European patent EP-0 716 115 describes a process for preparing a silicone composition for high-speed coating with rolls, said composition being presented as permitting a reduction in mist density. According to this process, a trimethylsilyl-terminated polydimethylmethylhydrosiloxane with a degree of polymerization of 12, and also 0.01% of a polydimethylsiloxane which is substituted with perfluoroethylbutyl and methylvinyl functions, whose end groups are dimethylvinylsiloxy groups, and whose degree of polymerization is 300, and also polypropylene glycol and, optionally, a stearyl or oleyl alcohol are employed. This leads to polydimethylsiloxanes which are functionalized with polyoxypropylene groups. These functionalized polydimethylsiloxanes are combined with other functionalized polydimethylsiloxanes, functionalized for example with hexenyl units, and are also combined with a platinum-based hydrosilylation catalyst, to form silicone coating compositions which permit a reduction in mist formation. The functionalization units may be hydrophobic residues such as stearic or oleic acid residues.

The U.S. Pat. No. 4,808,391 relates to silicone-based inks and varnishes, and more specifically to a method of applying these inks/varnishes to a substrate, using a roller coating machine operating at high speed. This patent discloses, in particular, compositions comprising vinyl-terminated polydimethylsiloxanes with a viscosity at 25° C. of between 15 000 and 50 000 mPa·s. These liquid coating compositions further comprise a platinum-based catalyst and a Theological additive composed of silica with a high specific surface area, more particularly fumed silica.

The U.S. Pat. No. 6,057,033 discloses silicone compositions intended for coating on flexible supports to form, after UV-induced cationic crosslinking, a release coating. In addition to the polyorganosiloxanes, these compositions comprise cellulose fibers which have an average length of between 15 and 100 μm and an average thickness of between 5 and 40 μm. The polyorganosiloxanes employed are polyorganosiloxanes which are functionalized with crosslinking groups of acryloxy or methacryloxy type, allowing UV-induced free-radical crosslinking.

The cellulose fibers incorporated into the composition make it possible to provide a solution to the technical problem, which is that of obtaining a nonbrittle crosslinked silicone release coating. The cellulose fibers are presented as producing improvements with regard to the transfer of the silicone coating film to the support, resistance to die cutting, mechanical properties (tensile resistance and tearing resistance), the anchoring of the coating to the paper, the reduction of the absorption of the coating liquid within the paper, and, incidentally, the reduction of mist formation.

On this last point, U.S. Pat. No. 6,057,033 does not provide any quantitative element for assessing the reduction in mist to which the cellulosic fibers give rise. There is good reason to think that this reduction remains completely inadequate.

Also cited, for report, is Japanese patent application JP-62 64 011, which describes a coating liquid comprising a film-forming resin and a solvent and which further comprises wax particles with a diameter of between 1 and 10 μm, the diameter of the coarsest particle being not more than 150% of the thickness of the wet film coating applied to the support. A coating liquid of this kind would allow an increase in coating speed of at least 10 to 30 m/min, by virtue a priori of a limitation on the formation of mist. The teaching of such a document is remote since it does not relate to silicone coatings.

In the light of this prior art, one of the essential objectives of the invention is to provide an effective method of controlling misting when coating flexible supports with a liquid silicone composition which is a precursor of crosslinked coatings, said coating taking place with the aid of a roll coating device operating at high speed.

Another essential objective of the invention is to provide a simple and economic method of controlling misting when coating flexible supports with a silicone composition intended for crosslinking, said coating taking place in a roll coating device operating at high speed.

Another essential objective of the invention is to provide a new additive which makes it possible to reduce the formation of mist when coating flexible materials, at high speed on rolls, by means of silicone compositions which can be crosslinked to give release coatings.

Another essential objective of the invention is to provide a method of controlling misting in the context of the coating of flexible supports, with a silicone composition which can be crosslinked to give release coatings, using a roll coating device.

All of these objectives, among others, are attained by the present invention, which first provides a method of controlling misting when coating flexible supports, comprising the following steps:

a) preparing a liquid silicone composition X, a precursor of silicone coating(s), comprising:
at least one polyorganosiloxane A crosslinkable by polyaddition, by dehydrocondensation, by polycondensation, cationically or free-radically,
optionally at least one crosslinking organosilicon compound B,
optionally at least one catalyst or photoinitiator C of a kind selected according to the type of reaction envisaged for said polyorganosiloxane A,
optionally at least one adhesion modulator system K, and
optionally at least one crosslinking inhibitor D; and
   b) coating said liquid silicone composition X onto a flexible support by means of a roll coating device,
   said method being characterized in that in step a) said liquid silicone composition X is admixed with an antimisting additive E having the following features:
it is in a liquid form, optionally following dilution by means of a diluent J′ or a solvent J″,

the tangent of the loss angle δ (tan δ) of said antimisting additive E, which is the ratio of the viscous modulus (G″) to the elastic modulus (G′), is >than 1, and
it is obtainable, and preferably obtained:
   1) by reacting, preferably at a temperature between 0° C. and 200° C.:
at least one organosiloxane monomer, oligomer and/or polymer F having per molecule at least one reactive ≡SiH unit with
at least one organosiloxane monomer, oligomer and/or polymer G exhibiting per molecule at least one reactive—SIOH and/or ≡SiR unit, where R is a C₁-C₄₀ carbinol radical, in the presence:
of at least one dehydrocondensation catalyst Hr and
of, optionally, at least one crosslinking inhibitor I and/or at least one solvent J,
   the nature and the amounts of components F and G being determined such that the ratio [number of reactive ≡SiOH units]:[number of reactive ≡SiH units]≠1:1, and
   2) by isolating the antimisting additive E, where appropriate after removal of the dehydrocondensation catalyst H and/or devolatilization and/or addition of a crosslinking inhibitor I′.

The inventors are meritorious in having obtained effective control over mist formation, which is manifested in a signifi-cant amelioration of the problem associated with the incidence of said mist in a roll coating system operating at high speed.

The conditions defined in the way of preparing the antimisting additive E, i.e., the nature of the reaction (dehydrocondensation reaction) and the requirement to operate with a ratio [number of reactive ≡SiOH units]:[number of reactive ≡SiH units]≠1:1, allows an additive to be obtained in a liquid form which exhibits entirely remarkable antimisting properties. Without wishing to be tied to any one scientific theory or any one mechanism, it appears that this property of the antimisting additive E according to the invention is due to the selection of this ratio and to the nature of the reaction involved (dehydrocondensation reaction), which make it possible to obtain branched polymers having viscoelastic properties which are useful for controlling misting in a roll coating system operating at high speed. The rheological behavior of the antimisting additive E according to the invention may also be illustrated by the value of its elastic (G′) and viscous (G″) moduli. The antimisting additive E according to the invention:

a) is in a liquid form, optionally after dilution with a diluent J′ or a solvent J″, and
b) the tangent of the loss angle δ (tan δ) of said antimisting additive E, which is the ratio of the viscous modulus (G″) to the elastic modulus (G′), is >than 1.

The antimisting additive E according to the invention is employed in amounts which are sufficient to reduce the quantity of misting during coating. A skilled worker is of course able, by means of routine tests, to determine these amounts without difficulty. For example, he or she is able to employ the additive according to the invention in amounts of between 0.1 to 15 parts by weight relative to the total weight of the liquid silicone composition X which is a precursor of silicone coating(s).

“Dehydrocondensation” is a reaction between ≡SiH units and, on the other hand, ≡SiOH units, leading to the formation of ≡Si—O—Si≡ bonds and to the release of gaseous hydrogen. This reaction is catalyzed by an effective amount of a dehydrocondensation catalyst H.

A skilled person will know to determine the effective amount of the dehydrocondensation catalyst H in accordance with the type of catalyst used.

An effective amount for the purposes of the invention is the amount sufficient to initiate the reaction. This amount must be as low as possible, in order to allow an optimum shelf life of the composition. Useful concentrations of the catalyst are between 1·10⁻⁶ and 5, preferably between 1·10⁻⁶ and 1·10⁻², parts by weight of the organosiloxane polymer solids to be reacted.

Any catalyst capable of initiating a dehydrocondensation reaction will be suitable. Metal catalysts based on platinum, rhodium, palladium, ruthenium, boron, tin or iridium, the platinum catalysts being the most common (FR-B-1 209 131, U.S. Pat. No. 4,262,107, EP-A-1 167 424, FR-A-2 806 930).

For example, it is possible to use a rhodium complex (RhCl₃[(C₈H₁₇)₂S]₃) cited in the U.S. Pat. No. 4,262,107, a platinum complex such as the Karstedt catalyst, and metal catalysts based on platinum, rhodium, palladium, tin or iridium. Iridium-based catalysts include the following compounds: IrCl(CO)(TPP)₂, Ir(CO)₂(acac); IrH(Cl)₂(TPP)₃; [IrCl (cyclooctene)₂]₂ IrI(CO)(TPP)₂ and IrH(CO)(TPP)₃, TPP in these formulae signifying a triphenylphosphine group, and acac an acetylacetonate group.

It is also possible to use catalysts such as dibutyltin dilaurate or those cited in the Noll work “Chemistry and technology of silicones”, pages 205 and 307, Academic Press, 1968-2nd edition). Other catalysts such as boron derivatives of tris(pentafluorophenyl)borane type are described in French patent application FR-A-2 806 930. FR-B-1 209 131 discloses in particular a catalyst based on chloroplatinic acid (H₂PtCl₆.6H₂O).

The crosslinking inhibitor D is generally used in order to endow the ready-to-use composition with a certain pot life. By varying on the one hand the nature of the catalytic entity and its concentration in the composition (giving rise to a given crosslinking rate) and on the other hand on the nature of the retardant and its concentration, it is possible to adjust the pot life. The activity of the catalytic entity is released by heating (thermal activation). The retardant is preferably selected from acetylenic alcohols (ethynylcyclohexanol: ECH) and/or diallyl maleates and/or triallyl isocyanurates and/or dialkyl maleates (diethyl maleates and/or dialkyl alkynyldicarboxylates) (diethyl acetylenedicarboxylate) or else from polyorganosiloxanes, which advantageously are cyclic and substituted by at least one alkenyl, with tetramethylvinylcyclo-tetrasiloxane being particularly preferred, or alkyl-containing maleates.

Acetylenic alcohols (see, for example, FR-B-1 528 464 and FR-A-2 372 874) are retardants which are useful according to the invention. Examples include the following:
1-ethynylcyclohexan-1-ol;
3-methyldodec-1-yn-3-ol;
3,7,11-trimethyldodec-1-yn-3-ol;
1,1-diphenylprop-2-yn-1-ol;
3-ethyl-6-ethylnon-1-yn-3-ol;
3-methylpentadec-1-yn-3-ol.

These α-acetylenic alcohols are commercial products.

Other examples of retardants useful according to the invention include phosphine derivatives, for example tris(2,4-di-tert-butylphenyl) phosphite (sold by Ciba under the name Irgafos 168®), or those described in international patent application WO 2004/061003, and in particular the compound Irgafos® P-EPQ of formula:

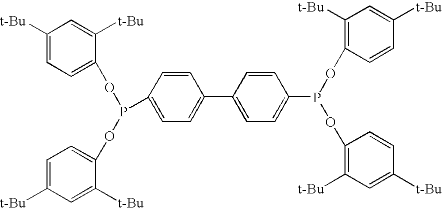

A retardant of this kind is present in particular at 1-100 molar equivalents/metal of the catalyst system.

The crosslinking inhibitors I and I′ envisaged for the method according to the invention are, for example, those described for the inhibitor D. Preferably I′ is tris(2,4-di-tert-butylphenyl) phosphite (sold by Ciba under the name of Irgafos 168®).

In the liquid silicone composition X which is a precursor of silicone coating(s), it may be advantageous to employ at least one adhesion modulator system K, in order to allow control over the release properties of the crosslinked silicone coating.

As an illustration of adhesion modulator systems in silicone formulations for release on paper or adhesive tape having a polymeric carrier, mention may be made of European patent application EP-A-0 601 938, the content of which is included in its entirety in the present specification.

According to one version the adhesion modulator system K is:
in the case of a formulation crosslinking by polyaddition: a polyorganosiloxane resin of formula MD^{Vi}Q; MM^{Vi}Q; MM^{Vi}D^{Vi}Q; MM^{Vi}DD^{Vi}Q; MD^{H}Q or MM^{H}Q;
in the case of a formulation crosslinking by poly-condensation: a polyorganosiloxane resin of formula M^{OH}Q; and
in the case of a formulation crosslinking under radiation: a polyorganosiloxane resin of formula MD′Q or MM′Q.

Examples of diluent and/or solvent J, J′ and J″ include aliphatic and aromatic solvents and chlorinated solvents, examples being white spirit, ketones such as methyl ethyl ketone and acetone, alcohols such as isopropanol and n-butyl alcohol, saturated, unsaturated or aromatic hydrocarbons, advantageously pentane, hexane, heptane, octane, toluene, xylene, and benzene, and “naphtha” petroleum cuts; C₇-C₈ petroleum cuts, halogenated hydrocarbons, and mixtures thereof.

The polyorganosiloxanes A of the liquid silicone composition X which is a precursor of silicone coating(s) may be of the type which crosslink at ambient temperature or in response to heat by polyaddition reactions in the presence of a metal catalyst, in this case a platinum-based catalyst. These are crosslinkable polyorganosiloxane compositions referred to as RTV (room temperature vulcanizing) or polyaddition polyorganosiloxane compositions called HTV, which is the abbreviation of “high-temperature vulcanizable”.

The two-component or one-component RTV or polyaddition HTV polyorganosiloxane compositions cure or crosslink essentially by reaction of hydrosilyl groups with silyl alkenyl groups, generally in the presence of a metal catalyst (preferably a platinum catalyst). They are described, for example, in U.S. Pat. Nos. 3,220,972, 3,284,406, 3,436,366, 3,697,473, and 4 340 709.

The polyorganosiloxanes A may also be a type which crosslink at ambient temperature by polycondensation reactions under the action of moisture, generally in the presence of a metal catalyst, a tin compound for example (polycondensation RTV). The compositions which employ this type of polyorganosiloxane are described, for example, in U.S. Pat. Nos. 3,065,194, 3,542,901, 3 779 986, and 4 417 042 and in patent FR-2 638 752 (one-component compositions) and in U.S. Pat. Nos. 3,678,002, 3,888,815, 3,933,729, and 4,064,096 (two-component compositions).

The polyorganosiloxanes A which are part of these polycondensation RTV compositions are linear, branched or crosslinked polysiloxanes which carry hydroxyl groups or hydrolysable groups, alkoxy groups for example. Such compositions may further comprise a crosslinking agent which is, in particular, a compound bearing at least three hydrolysable groups, such as a silicate, an alkyltrialkoxysilane or an aminoalkyltrialkoxysilane, for example.

The liquid silicone composition X may further comprise one or more polyorganosiloxanes A which are crosslinkable cationically or free-radically:
in the presence of an effective amount of cationic initiator systems (thermal initiators and/or photoinitiators)-organometallic complex or onium borate initiators, proton-donating organic solvents (isopropyl alcohol, benzyl alcohol, etc.), and/or
where appropriate in the presence of a free-radical initiator, via activation with actinic radiation (UV) or with electron beams.

These polyorganosiloxanes are, for example, linear or cyclic epoxysilicones and/or vinyl ethyl silicones. Epoxy- or vinyloxy-functional polyorganosiloxanes of this kind are described in particular in patents DE-4 009 889, EP-0 396 130, EP-0 355 381, EP-0 105 341, FR-2 110 115, FR-2 526 800.

The epoxy-functional polyorganosiloxanes may be prepared by hydrosilylation reactions of oils containing ≡SiH units with epoxy-functional compounds such as 4-vinylcyclohexenone or allyl glycidyl ether. The vinyloxy-functional polyorganosiloxanes may be prepared by hydrosilylation reaction of oils containing SiH units with vinyloxy-functional compounds such as allyl vinyl ether or allylvinyloxyethoxybenzene.

According to one preferred version of the method according to the invention, the liquid silicone composition X, a precursor of silicone coating(s), which is admixed with the antimisting additive E, comprises:
at least one polyorganosiloxane A crosslinkable by polyaddition,
optionally at least one crosslinking organosilicon compound B,
at least one catalyst C1 of the polyaddition reaction, optionally at least one adhesion modulator system K, and optionally at least one crosslinking inhibitor D.

According to this preferred version, the polyorganosiloxane A is of the type which crosslink by polyaddition and exhibits siloxy units of the formula (III) with optionally at least some of the other units being siloxy units of average formula (IV):

$$\begin{matrix}{W}_{a} {Z}_{b} SiO \frac{4 - ( a + b )}{2} & ( III ) \\ {Z}_{c} SiO \frac{4 - c}{2} & ( IV )\end{matrix}$$

in which formulae:
W is an alkenyl group, preferably vinyl or allyl,
the symbols Z, which are identical or different, represent:
   a linear or branched alkyl radical which contains 1 to 20 carbon atoms and is optionally substituted by at least one halogen, preferably fluorine, the alkyl radicals being preferably methyl, ethyl, propyl, octyl, and 3,3,3-trifluoropropyl,
   a cycloalkyl radical which contains between 5 and 8 cyclic carbon atoms and is optionally substituted,
   an aryl radical which contains between 6 and 12 carbon atoms and is optionally substituted, and/or
   an aralkyl moiety which has an alkyl moiety containing between 5 and 14 carbon atoms and an aryl moiety containing between 6 and 12 carbon atoms and is optionally substituted on the aryl moiety by halogens and/or alkyls,
a is 1 or 2, preferably 1, b is 0, 1 or 2, and a+b=1, 2 or 3, and
c=0, 1, 2 or 3.

Examples of polyorganosiloxanes A crosslinkable by polyaddition are dimethylvinylsilyl-terminated dimethylpolysiloxanes, trimethylsilyl-terminated methylvinyldimethylpolysiloxane copolymers, and dimethylvinylsilyl-terminated methylvinyldimethylpolysiloxane copolymers.

The crosslinking organosilicon compound B is preferably of the type which exhibits units of formula (V) with optionally at least some of the other units being units of average formula (VI):

HL_{c}SiO_{(3-c)/2} (V)

L_{g}SiO_{(4-g)/2} (VI)

in which:
the symbols L, which are identical or different, represent:
   a linear or branched alkyl radical which contains 1 to 20 carbon atoms and is optionally substituted by at least one halogen, preferably fluorine, the alkyl radicals being preferably methyl, ethyl, propyl, octyl, and 3,3,3-trifluoropropyl,
   a cycloalkyl radical which contains between 5 and 8 cyclic carbon atoms and is optionally substituted,
   an aryl radical which contains between 6 and 12 carbon atoms and is optionally substituted, and/or
   an aralkyl moiety which has an alkyl moiety containing between 5 and 14 carbon atoms and an aryl moiety containing between 6 and 12 carbon atoms and is optionally substituted on the aryl moiety by halogens and/or alkyls,
c=0, 1 or 2, and
g=0, 1, 2 or 3.

Examples of crosslinking organosilicon compound B are, for example:
hydrodimethylsilyl-terminated dimethylpolysiloxane polymers,
poly(dimethylsiloxane)(methylhydrosiloxy) α,ω-dimethylhydrosiloxane polymers,
MDD′: copolymers containing dimethylhydromethylpolysiloxane (dimethyl) units having trimethylsilyl end groups,
M′DD′: copolymers containing dimethylhydromethyl-polysiloxane units having hydrodimethylsilyl end groups,
MD′: hydromethylpolysiloxanes having trimethylsilyl end groups.

The polyaddition catalyst C1 is composed, for example, of at least one metal belonging to the platinum group. This catalyst may in particular be selected from platinum compounds and rhodium compounds. Use may be made in particular of the complexes of platinum with an organic product described in U.S. Pat. No. 3,159,601, U.S. Pat. No. 3,159,602, U.S. Pat. No. 3,220,972 and European patents EP-A-0 057 459, EP-A-0 188 978, and EP-A-0 190 530, and the complexes of platinum and vinylorganosiloxanes described in U.S. Pat. No. 3,419,593, U.S. Pat. No. 3,715,334, U.S. Pat. No. 3,377,432, and U.S. Pat. No. 3,814,730. The catalyst generally preferred is platinum. In this case the amount by weight of the polyaddition catalyst C1, calculated by weight of platinum metal, is generally between 2 and 400 ppm.

Besides these constituents, the liquid silicone composition X which is a precursor of silicone coating(s) may further comprise at least one additive which is common in silicone compositions which crosslink by polyaddition, by polycondensation, cationically or free-radically. Mention may be made, for example, of pigments, etc.

According to one advantageous embodiment of the method according to the invention, the antimisting additive E has the following features:
it is in a liquid form, optionally following dilution by means of a diluent J′ or a solvent J″,
the tangent of the loss angle δ (tan δ) of said antimisting additive E, which is the ratio of the viscous modulus (G″) to the elastic modulus (G′), is >than 1, and
it is obtainable, and preferably obtained:

1) by reacting, preferably at a temperature between 0° C. and 200° C.:
at least one organosiloxane monomer, oligomer and/or polymer F having per molecule at least one reactive ≡SiH unit with
at least one organosiloxane monomer, oligomer and/or polymer G exhibiting per molecule at least one reactive ≡SiOH and/or ≡SiR unit, where R is a C₁-C₄₀ carbinol radical, in the presence:
of a dehydrocondensation catalyst H, preferably a platinum-based metal catalyst, and
of, optionally, at least one crosslinking inhibitor I, the nature and the amounts of components F and G being determined such that:
a) the ratio: [number of reactive ≡SiOH units]:[number of reactive ≡SiH units]<1:1, preferably <1:2 or more preferably between 1:3 and 1:50, and more preferably still between 1:3 and 1:15, and

2) by isolating the antimisting additive E, where appropriate after removal of the dehydrocondensation catalyst H and/or devolatilization and/or addition of a crosslinking inhibitor I′.

According to this version the antimisting additive E is a branched polymer or a mixture comprising at least one branched polymer comprising per molecule at least one reactive ≡SiH unit.

It is very advantageous to prepare the additive with a ratio [number of reactive ≡SiOH units]:[number of reactive ≡SiH units] of between 1:3 and 1:50, and more preferably still between 1:3 and 1:15. The reason is that maintaining this ratio within these ranges allows an antimisting additive to be prepared which does not exhibit gelling problems, thereby obviating dilution with a solvent or a diluent, while having an appropriate degree of branching, which is to say that the degree of branching must not be too great but must be sufficient to obtain the additive in a liquid form while maintaining the viscoelastic properties appropriate for obtaining the antimisting effect.

The use of a platinum-based metal catalyst as dehydro-condensation catalyst H makes it possible to improve the antimisting performance of the additive thus obtained.

According to one preferred embodiment of the method according to the invention, the particularly advantageous antimisting additive E obtained according to the method of preparation described above has the average formula:

MₐD_{b}D′_{c}T_{d}

where:
a, c and d are numbers >than 0,
b≧0,
0.5 mol %<c<10 mol %,
0.05 mol %<d<10 mol %,
D′=HR²²SiO_{2/2},
T=R²³SiO_{3/2},
M=R²⁴R²⁵R²⁶SiO_{1/2},
D=R²⁷R²⁶SiO_{2/2};
   it being possible for said antimisting additive E to contain up to 10 mol % of residual units DOH and/or TOH where:
D^{OH}=R²⁹R³⁰(OH) SiO_{1/2}, and
T=R³¹(OH)SiO_{2/2},
   the symbols R²², R²³, R²⁴, R²⁵, R²⁶, R²⁷, R²⁸, R²⁹, R³⁰, and R³¹, which are identical or different, represent, each independently of one another:
a linear or branched alkyl radical which contains 1 to 20 carbon atoms and is optionally substituted by at least one halogen, preferably fluorine, the alkyl radicals being preferably methyl, ethyl, propyl, octyl, and 3,3,3-trifluoropropyl,
a cycloalkyl radical which contains between 5 and 8 cyclic carbon atoms and is optionally substituted,
an aryl radical which contains between 6 and 12 carbon atoms and is optionally substituted, and/or
an aralkyl moiety which has an alkyl moiety containing between 5 and 14 carbon atoms and an aryl moiety containing between 6 and 12 carbon atoms and is optionally substituted on the aryl moiety by halogens and/or alkyls.

According to one particularly advantageous version of the method, in step 1) the dehydrocondensation catalyst H is a platinum-based metal catalyst, and
after step 1) the reaction product obtained from step 1) is reacted, preferably at a temperature between 0° C. and 200° C., with at least one compound of formula CH₂═CHR^{a}, the amount of the reactants preferably being selected such that the ratio [number of reactive ≡SiH units]:[number of reactive CH₂═CH— functions]≦1:1,
R^{a} being a monovalent radical selected from the group consisting of halogens, hydrogen, a C₁-C₆₀ hydrocarbon radical, a C₁-C₆₀ polyester radical, a C₁-C₆₀ nitrile radical, a C₁-C₆₀ haloalkyl radical, a radical containing one or more silicon atoms, and a C₁-C₆₀ polyether radical, and

2) the antimisting additive E is isolated, optionally after removal of the dehydrocondensation catalyst H and/or devolatilization and/or addition of a crosslinking inhibitor I′.

According to another version of the method according to the invention, the antimisting additive E is a branched polyorganosiloxane L or a mixture comprising at least one branched polyorganosiloxane L, said antimisting additive E containing at least one reactive ≡SiOH and/or ≡SiR unit, with R being a carbinol radical, and has the following features:
it is present in a liquid form, optionally following dilution by means of a diluent J′ or a solvent J″,
the tangent of the loss angle δ (tan δ) of said antimisting additive E, which is the ratio of the viscous modulus (G″) to the elastic modulus (G′), is >than 1, and
it is obtainable, and preferably obtained:

1) by reacting, preferably at a temperature between 0° C. and 200° C.:
at least one organosiloxane monomer, oligomer and/or polymer F having per molecule at least one reactive ≡SiH unit with
at least one organosiloxane monomer, oligomer and/or polymer G exhibiting per molecule at least one reactive ≡SiOH and/or ≡SiR unit, where R is a C₁-C₄₀ carbinol radical, in the presence:
of a dehydrocondensation catalyst H, and
of, optionally, at least one crosslinking inhibitor I and/or at least one solvent J,
   the nature and the amounts of components F and G being determined such that the ratio: [number of reactive ≡SiH units]:[number of reactive ≡SiOH and/or number of ≡Si-carbinol units]<1:1, preferably <1:2 or more preferably between 1:3 and 1:50, and

2) by isolating the antimisting additive E, where appropriate after removal of the dehydrocondensation catalyst H and/or devolatilization and/or addition of a crosslinking inhibitor I′.

Component F is preferably an organosiloxane monomer, oligomer and/or polymer F which has per molecule at least one reactive ≡SiH unit and has the general formula:

MᵤDᵥD′_{w}TₓQ_{y}M′_{z}

in which:
u, y, w, x, and z are numbers ≧than/to 0, with w+z>0, and preferably y=0,
M=R¹R²R³SiO_{1/2},
D=R⁴R⁵SiO_{2/2},
D′=HR⁶SiO_{2/2},
T=R⁷SiO_{3/2},
Q=SiO_{4/2},
M′=HR⁸R⁹SiO_{4/2},
   with the symbols R¹, R², R³, R⁴, R⁵, R⁶, R⁷, R⁸, and R⁹, which are identical or different, representing each independently of one another:
a linear or branched alkyl radical which contains 1 to 20 carbon atoms and is optionally substituted by at least one halogen, preferably fluorine, the alkyl radicals being preferably methyl, ethyl, propyl, octyl, and 3,3,3-trifluoropropyl,
a cycloalkyl radical which contains between 5 and 8 cyclic carbon atoms and is optionally substituted,
an aryl radical which contains between 6 and 12 carbon atoms and is optionally substituted, and/or
an aralkyl moiety which has an alkyl moiety containing between 5 and 14 carbon atoms and an aryl moiety containing between 6 and 12 carbon atoms and is optionally substituted on the aryl moiety by halogens and/or alkyls.

Examples of constituent F include polymethylhydrosiloxanes having trimethylsiloxy and/or hydrodimethylsiloxy end groups. Very particularly suitable for the invention, for example, are the following compounds:

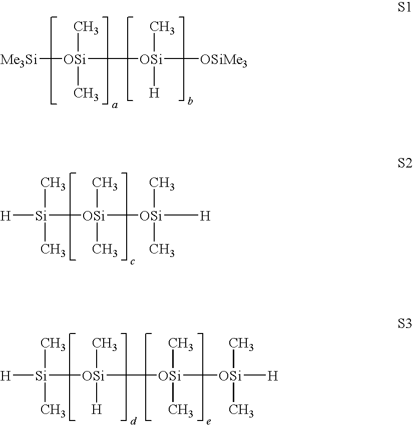

where a, b, c, d, and e represent a number ranging from 0 to 500;
in the polymer of formula S1:
   0≦a≦500, preferably 1≦a≦150, preferably 1≦a≦10, and 1≦b≦500, preferably 1≦b≦50, preferably 1≦b≦10;
in the polymer of formula S2:
   0≦c≦500;
in the polymer of formula S3:
   0≦d≦50, preferably 1≦d≦50 and 0≦e≦500, preferably 1≦e≦150.

The compound G is preferably an organosiloxane monomer, oligomer and/or polymer G which exhibits per molecule at least one reactive ≡SiOH and/or ≡SiR unit, where R is a carbinol radical, and is selected from the group consisting of the structures of formulae (I) and (II):

(D^{OH})ᵢDⱼ(TH^{OH})ₖTₗQₘMₙ (I)

Mₒ(D^{R})ₚD_{q}TᵣQₛ(M^{R})ₜ (II)

in which:
i, j, k, l, m, and n are numbers ≧than/to 0, with i+k>0, and preferably m=0 and s=0,
o, p, q, r, s, and t are numbers ≧than/to 0, with p+t>0,
M=R¹⁰R¹¹R¹²SiO_{1/2},
D=R¹³R¹⁴SiO_{2/2},
D^{R}=RR¹⁵SiO_{2/2},
T=R¹⁶SiO_{3/2},
Q=SiO_{4/2},
M^{R}=RR¹⁷R¹⁸SiO_{1/2},
D^{OH}=R¹⁹R²⁰(OH)SiO_{1/2},
T^{OH}=R²¹(OH)SiO_{2/2},
R is a C₁-C₄₀ carbinol group, and
the symbols R¹⁰, R¹¹, R¹², R¹³, R¹⁴, R¹⁵, R¹⁶, R¹⁷, R¹⁸R¹⁹, R²⁰, and R²¹, which are identical or different, represent, each independently of one another:
   a linear or branched alkyl radical which contains 1 to 20 carbon atoms and is optionally substituted by at least one halogen, preferably fluorine, the alkyl radi-cals being preferably methyl, ethyl, propyl, octyl, and 3,3,3-trifluoropropyl,
   a cycloalkyl radical which contains between 5 and 8 cyclic carbon atoms and is optionally substituted,
   an aryl radical which contains between 6 and 12 carbon atoms and is optionally substituted, and/or
   an aralkyl moiety which has an alkyl moiety containing between 5 and 14 carbon atoms and an aryl moiety containing between 6 and 12 carbon atoms and is optionally substituted on the aryl moiety by halogens and/or alkyls.

Very particularly suitable for the invention as component G are the compounds of formula

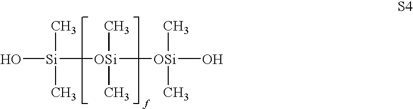

where 1≦f≦1200, preferably 1≦f≦500, and more preferably still 4≦f≦250.

In accordance with another of its aspects, the invention provides a branched polyorganosiloxane L′, or a mixture comprising at least one branched polyorganosiloxane L′, characterized in that:
it is in a liquid form,
the tangent of the loss angle δ (tan δ) of said branched polyorganosiloxane L′ or of the mixture comprising at least said branched poly-organosiloxane L′, which is the ratio of the viscous modulus (G″) to the elastic modulus (G′), is >than 1, and
it is obtainable:

1) by reacting, preferably at a temperature between 0° C. and 200° C.:
at least one organosiloxane monomer, oligomer and/or polymer F having per molecule at least one reactive ≡SiH unit with
at least one organosiloxane monomer, oligomer and/or polymer G exhibiting per molecule at least one reactive ≡SiOH and/or ≡SiR unit, where R is a C₁-C₄₀ carbinol radical, in the presence:
of a dehydrocondensation catalyst H which is a platinum-based metal catalyst, and
of, optionally, at least one crosslinking inhibitor I, the nature and the amounts of components F and G being determined such that:
a) the ratio: [number of reactive ≡SiOH units]:[number of reactive ≡SiH units] is between 1:3 and 1:50, and

2) by isolating the antimisting additive E, where appropriate after removal of the dehydrocondensation catalyst H and/or devolatilization and/or addition of a crosslinking inhibitor I′.

The description of the constituents used for the preparation of the branched polyorganosiloxanes L′ and L″ is as set out for the method of the invention.

The branched polyorganosiloxane L′ obtained according to the method described above contains reactive ≡SiH functions and has the advantage of being present in a liquid form, which facilitates its use in the liquid silicone composition X which is a precursor of silicone coating(s). Moreover, the use of a platinum-based metal catalyst as dehydrocondensation catalyst H makes it possible, surprisingly, to obtain a much more effective antimisting additive.

According to one preferred version of the method of preparing the branched polyorganosiloxane L′ or the mixture comprising at least one branched polyorganosiloxane L′:
after step 1) the reaction product obtained from step 1) is reacted, preferably at a temperature between 0° C. and 200° C., with at least one compound of formula CH₂═CHR^{a}, the amount of the reactants preferably being selected such that the ratio [number of reactive ≡SiH units]:[number of reactive CH₂═CH— functions]≦1:1,
R^{a} being a monovalent radical selected from the group consisting of halogens, hydrogen, a C₁-C₆₀ hydrocarbon radical, a C₁-C₆₀ polyester radical, a C₁-C₆₀ nitrile radical, a C₁-C₆₀ haloalkyl radical, a radical containing one or more silicon atoms, and a C₁-C₆₀ polyether radical.

According to one advantageous embodiment the branched polyorganosiloxane L′ or mixture comprising at least one branched polyorganosiloxane L′ has the average formula:

MₐD_{b}D′_{c}T_{d}

where:
a, c and d are numbers >than 0,
b≧0,
0.5 mol %≦c≦10 mol %,
0.05 mol %≦d≦9 mol %,
D′=HR²²SiO_{2/2},
T=R²³SiO_{3/2},
M=R²⁴R²⁵R²⁶SiO_{1/2},
D=R²⁷R²⁶SiO_{2/2};
   it being possible for said branched polyorganosiloxane L′ to contain up to 10 mol % of residual units D^{OH} and/or T^{OH} where:
D^{OH}=R²⁹R³⁰(OH) SiO_{1/2}, and
T^{OH}=R³¹(OH)SiO_{2/2},
   the symbols R²², R²³, R²⁴, R²⁵, R²⁶, R²⁷, R²⁸, R²⁹, R³⁰, and R³¹, which are identical or different, represent, each independently of one another:
a linear or branched alkyl radical which contains 1 to 20 carbon atoms and is optionally substituted by at least one halogen, preferably fluorine, the alkyl radicals being preferably methyl, ethyl, propyl, octyl, and 3,3,3-trifluoropropyl,
a cycloalkyl radical which contains between 5 and 8 cyclic carbon atoms and is optionally substituted,
an aryl radical which contains between 6 and 12 carbon atoms and is optionally substituted, and/or
an aralkyl moiety which has an alkyl moiety containing between 5 and 14 carbon atoms and an aryl moiety containing between 6 and 12 carbon atoms and is optionally substituted on the aryl moiety by halogens and/or alkyls.

The invention also provides a branched polyorganosiloxane L″ or a mixture comprising at least one branched polyorganosiloxane L″, characterized in that:
said branched polyorganosiloxane L″ contains at least one reactive ≡SiOH and/or ≡SiR unit, where R is a carbinol radical,
it is present in a liquid form, optionally following dilution by means of a diluent J′ or a solvent J″,
the tangent of the loss angle δ (tan δ) of said branched polyorganosiloxane L″ or of the mixture comprising at least said branched polyorganosiloxane L″, which is the ratio of the viscous modulus (G″) to the elastic modulus (G′), is >than 1, and
it is obtainable:

1) by reacting, preferably at a temperature between 0° C. and 200° C.:
at least one organosiloxane monomer, oligomer and/or polymer F having per molecule at least one reactive ≡SiH unit with
at least one organosiloxane monomer, oligomer and/or polymer G exhibiting per molecule at least one reactive ≡SiOH and/or ≡SiR unit, where R is a C₁-C₄₀ carbinol radical, in the presence:
of a dehydrocondensation catalyst H, and
of, optionally, at least one crosslinking inhibitor I and/or at least one solvent J,
   the nature and the amounts of components F and G being determined such that the ratio: [number of reactive ≡SiH units]:[number of reactive ≡SiOH and/or number of reactive ≡Si-carbinol units]<1:1, preferably <1:2 or more preferably between 1:3 and 1:50, and

2) by isolating the antimisting additive E, where appropriate after removal of the dehydrocondensation catalyst H and/or devolatilization and/or addition of a crosslinking inhibitor I′.

The invention additionally provides a liquid silicone composition X, a precursor of silicone coating(s), comprising:
at least one polyorganosiloxane A crosslinkable by polyaddition, by dehydrocondensation, by polycondensation, cationically or free-radically, and/or at least one adhesion modulator system K, and/or at least one crosslinking inhibitor D, and/or at least one crosslinking organosilicon compound B, and/or at least one catalyst or photoinitiator C of a kind selected according to the type of reaction envisaged for said polyorganosiloxane A, and
at least one antimisting additive E as described above.

The invention lastly provides for the use of the antimisting additive E as defined above to reduce misting when coating flexible supports with a liquid silicone composition X which is a precursor of silicone coating(s).

It is therefore apparent that the invention provides an original, simple, economic, and reliable means of counteracting the production of mist when coating flexible supports (of paper, film or polymeric film, for example) in roll coating devices operating at high speed. The practical industrial consequence is that the running speeds can be further increased without incidence of this misting phenomenon, which is detrimental to the quality of coating. The means of control provided by the invention also has the not-insignificant advantage of not affecting the appearance qualities, coverage, release properties, and mechanical properties (rub-off) of the crosslinked silicone coating it is desired to obtain on at least one of the faces of the flexible support.

Furthermore, the reduction in misting significantly enhances the hygiene and safety conditions for personnel stationed around industrial devices for silicone coating on rolls operating at high speed.

The purpose of the examples below is to illustrate particular embodiments of the invention, without limiting the scope of the invention to these sole embodiments.

### EXAMPLES

### 1) Preparation of Antimisting Additives E

### Example 1

Under an inert atmosphere, 29.8 g of a silicone oil containing 0.0597 equivalent of ≡SiOH per 100 g, 50 g of a silicone oil containing 0.4 equivalent of ≡SiH per 100 g, 16 mg of a Karstedt Pt solution containing 10-12% Pt, and 25.3 mg of ethynylcyclohexanol (ECH) inhibitor are introduced. The mixture is heated and stirred at 120° C. for 6 h until the degree of conversion (DC) of the ≡SiOH groups is −95%. After cooling, 2.64 mg of Irgafos® 168, supplied by Ciba, are added. The branched silicone oil obtained has a viscosity of 168 mm2/s and contains 0.188 equivalent of ≡SiH/100 g [ratio SiH:SiOH=11.2:1].

### Example 2

Under an inert atmosphere, 436.4 g of a silicone oil containing 0.0597 equivalent of ≡SiOH per 100 g, 1020 g of toluene, and 80 mg of IrCl(CO) (PPh₃)₂ catalyst are introduced. At ambient temperature, 523.7 g of a silicone oil containing 0.4 equivalent of ≡SiH per 100 g are run into the mixture over 2 hours. The reaction mixture is stirred for a further 2.5 h until the DC of the ≡SiOH groups is −90%. After volatiles have been stripped off, the branched silicone oil obtained has a viscosity of 960 mm2/s and contains 0.09 equivalent of SiH per 100 g [ratio SiH:SiOH=8:1].

### Example 3

Under an inert atmosphere, 0.86 g of a silicone oil containing 0.455 equivalent of ≡SiOH per 100 g, 80 g of a silicone oil containing 0.052 equivalent of ≡SiH per 100 g, 16 mg of a Karstedt Pt solution containing 10-12% Pt, and 25.7 mg of (ECH) inhibitor are introduced. The mixture is heated and stirred at 120° C. for 6 h until the DC of the ≡SiOH is −85%. After cooling, 2.64 mg of Irgafos® 168 are added. The branched silicone oil obtained has a viscosity of 477 mm2/s and contains 0.045 equivalent of ≡SiH/100 g [ratio SiH:SiOH=10.6:1].

### Example 4

Under an inert atmosphere, 80 g of a silicone oil containing 0.014 equivalent of ≡SiOH per 100 g, 10 g of a silicone oil containing 0.4 equivalent of ≡SiH per 100 g, 18 mg of a Karstedt Pt solution containing 10-12% Pt, and 33 mg of (ECH) inhibitor are introduced. The mixture is heated and stirred at 120° C. for 6 h until the DC of the ≡SiOH is −75%. After cooling, 2.8 mg of Irgafos 168 are added. The branched silicone oil obtained has a viscosity of 31 000 mm2/s and contains 0.028 equivalent of ≡SiH/100 g [ratio SiH:SiOH=3.57:1].

### Example 5

Under an inert atmosphere, 10 g of xylene and 18 mg of a Karstedt Pt solution containing 10-12% Pt are introduced. The mixture is heated and stirred at 120° C. and then 65.5 g of a silicone oil containing 0.014 equivalent of ≡SiOH per 100 g and 24.4 g of a silicone oil containing 0.4 equivalent of SiH per 100 g are run together into the mixture over 3 hours. The reaction mixture is heated for a further 3 h at 120° C. until the DC of the ≡SiOH is −86%. After volatiles have been stripped off, the branched silicone oil obtained has a viscosity of 11 600 mm2/s and contains 0.087 equivalent of ≡SiH per 100 g [ratio SiH:SiOH=10.63:1]. The empirical formula of the product is determined by ²⁹Si and ¹H NMR is MD₅₂D′_{3.4}T_{0.6}M.

### Example 6

### Comparative in Relation to Example 5

For comparison, a branched silicone with empirical formula similar to that of example 5 was prepared by redistribution of 9.2 g of a resin of formula M_{0.7}D_{1.2}T_{3.3}, 164.4 g of cyclic polysiloxane of formula D₄ (octamethylcyclotetrasiloxane), 16.6 g of a silicone oil of formula M₂D₄ (tetradecamethylhexasiloxane), and 9.8 g of a polysiloxane with ≡SiH unit, of formula MD′50M, in the presence of Tonsil (montmorillonite sold by Süd-Chemie] at 75° C. for 20 h. Following filtration and removal of the volatiles by stripping, the branched silicone product obtained has a viscosity of 135 mm²/s. The empirical formula of the product, as determined by ²⁹Si and ¹H NMR, is MD₆₇D′_{3.6}T_{0.5}M. It should be noted that the empirical formula of this polymer is very close to that described for the polymer of example 5.

### Example 7

### Post-Functionalization

Under an inert atmosphere, 28.1 g of a silicone oil containing 0.014 equivalent of ≡SiOH and 26.3 mg of a Karstedt Pt solution containing 10-12% Pt are introduced. The mixture is heated and stirred at 100° C. and then 33.3 g of a silicone oil containing 0.4 equivalent of ≡SiH per 100 g and 78.8 g of the silicone oil containing 0.014 equivalent of ≡SiOH are run in simultaneously over 2 hours. The reaction mixture is subsequently heated at 100° C. for a further 2 h. The mixture is cooled to 85° C. and then 49 g of tetradecene are added. The mixture is heated at 85° C. for 3 h and then cooled. After volatiles have been stripped off, the branched silicone oil obtained has a viscosity of 2730 mm2/s and contains 0.4 milliequivalent of ≡SiH per 100 g.

### Example 8

### Ratio SiH/SiOH=2/1

Under an inert atmosphere, 160.15 g of a silicone oil containing 0.014 equivalent of ≡SiOH, 300 mg of a Karstedt Pt solution containing 10-12% Pt, and 20 g of a silicone oil containing 0.4 equivalent of ≡SiH per 100 g are introduced. The mixture is heated and stirred at 110° C. for 1.5 h, but leads to the formation of a gel, which means that it cannot be used as it is and requires dilution with a diluent or solvent.

Measurement of the parameter of tangent of the loss angle δ (tan δ)=the ratio of the viscous modulus (G″) to the elastic modulus (G′):

The viscoelasticity was measured at different frequencies for two examples, using a rheometer as follows: Rheometric ARES/diameter: 50 mm/cone angle/angle: 0.04 rad/cone-plane spacing: 53 μm.

The results obtained are collated in the table below.

TABLE I

| | 1 rad/s | | 100 rad/s | |
|---|---|---|---|---|
| | Complex | | Complex | |
| | viscosity | | viscosity | |
| 23° C. | η* (Pa · s) | tan δ | η* (Pa · s) | tan δ |
| Example 4 | 82 (+−4) | 1.56 (+−0.15) | 17.1 (+−0.1) | 1.60 (+−0.12) |
| Example 5 | 20.5 (+−0.7) | 3.48 (+−0.20) | 7.4 (+−0.1) | 2.50 (+−0.22) |

### II) Test as Antimisting Additive

Branched silicones prepared in section I) were tested as antimisting additives. The results observed are collated in the tables below, as a measured misting quantity (mg/m3) or in the form of a ratio of misting measured with additive and without additive for different roll rotation speeds.

### Description of the Test

To analyze and quantify the mist produced in a roll coating device operating at high speed, use was made on the laboratory scale of a 2-roll device (provided by Ermap, Grenoble, France) operating reproducibly and capable of conveying a web of paper at a linear speed of more than 900 m/min. The two press/coating rolls have a diameter of 10 cm. The press roll is covered with rubber and the coating roll with chromium. The coating roll was cut in dumbbell shape so that the speed of the two rolls is synchronous. The press roll, which can be driven by a motor, is in constant pressure contact with the coating roll. The silicone coating liquid is poured directly into the nip between the two rolls. The amount of fluid used is 0.25 ml.

Different compositions were then prepared by mixing a silicone polymer A1 (a polydimethylsiloxane whose end groups are blocked with a dimethylvinylsiloxy group, and whose viscosity is 220 mPa·s) and the products described above in examples 4 to 7, at a rate of 2 parts by weight of product in 100 parts by weight of polymer. The compositions are homogenized on a barrel rolling device for the time required. Then the rotary system described above is used on the rolls on which the preparation in question is spread. Subsequently the rotational speed of the rolls is progressively increased. In parallel, the density of the mist is measured by placing a measurement instrument referred to as a particle counter, which is sold by ITS (France), in proximity to the point of contact between the rolls. The result of the mist density measurement is expressed in mg of silicone aerosol per m³ of air at a given measurement speed.

The table below collates the results obtained:

TABLE II
Results of the antimisting tests as absolute values

| | Misting | Misting | Misting |
|---|---|---|---|
| Antimisting additive | (mg/m³) at | (mg/m³) at | (mg/m³) at |
| (2%) | 600 m/min | 800 m/min | 870 m/min |
| Reference without | 21 | 63 | 73 |
| additive (comparative) | | | |
| Example 2 (inventive) | 10 | 40 | 48 |
| Example 4 (inventive) | 2 | 6 | 12 |
| Example 5 (inventive) | 3 | 11 | 17 |
| Example 6 (comparative | 14 | 37 | 48 |
| in relation to example 5 | | | |
| Example 7 (inventive) | 4 | 18 | 27 |

These results show that a branched polymer according to the invention prepared with a Pt-based dehydrogenation catalyst (examples 4, 5, and 7) exhibits an activity which is 3 to 9 times greater than that of a branched polymer according to the invention prepared from an iridium-based dehydrogenation catalyst (example 2).

Moreover, a comparison of example 5 (inventive) and example 6 (comparative) shows that a branched polymer obtained by a dehydrocondensation reaction exhibits an antimisting activity which is greatly superior to that of a branched polymer obtained by another synthesis route.

TABLE III
Results of the antimisting tests in comparison
with a reference without additive

| | | | Misting |
|---|---|---|---|
| | Misting at | Misting at | (mg/m3) at |
| Antimisting additive | 600 m/min* | 800 m/min* | 870 m/min |
| Reference without | 1 | 1 | 1 |
| additive (comparative) | | | |
| Example 2 (inventive) | 0.48 | 0.63 | 0.66 |
| Example 4 (inventive) | 0.28 | 0.15 | 0.17 |
| Example 5 (inventive) | 0.08 | 0.17 | 0.23 |
| Example 6 (comparative | 0.68 | 0.64 | 0.69 |
| test in relation to example 5 | | | |
| Example 7 (inventive) | 0.23 | 0.31 | 0.38 |

### Preparation of a Silicone Release Coating on a Paper Support

Baths are obtained by mixing the following products in succession:
a polydimethylsiloxane silicone polymer whose ends are blocked with a dimethylvinylsiloxy group and whose viscosity is 220 mPa·s,
the additive according to the invention (examples 2, 4, 5, and 7),
a mixture of oils composed of polyhydromethylsiloxane and polydimethylsiloxane copolymers, the two types of copolymers being blocked with trimethylsiloxane groups,
a catalyst containing Pt (Karstedt catalyst) in solution in divinyltetramethyldisiloxane.

The proportions of the mixture are calculated such as to give, in the final bath, a ratio between the total number of moles of vinyl groups and the total number of moles of hydrosiloxane groups of 1.75, a platinum concentration of 110 ppm, and an ethynylcyclohexan-1-ol content of the order of 0.15% by weight relative to the weight of the formulation. Furthermore, the antimisting additive according to the invention is added to the polydimethylsiloxane silicone polymer whose ends are blocked with a dimethylvinylsiloxy group and whose viscosity is 220 mPa·s in a proportion of 2% by weight relative to the total weight of the formulation. These baths are then used in succession to coat a “glassine” paper support by means of a coating machine whose coating head is a head fitted with four wet rolls. Downstream of this head, a drying station in which air circulates at approximately 195° C. is used in order to cure the silicone coating by taking it to a maximum temperature of between 130 and 160° C.

After having carried out coating by using the above-described baths in succession, results are obtained which are comparable in terms of the reduction in mist during coating, the coating obtained being dry to the touch and of release character.

1. A method of controlling misting when coating a flexible support, comprising:
a) preparing a liquid silicone composition X, which is a precursor of a silicone coating, said composition comprising:
at least one polyorganosiloxane A crosslinkable by polyaddition, by dehydrocondensation, by polycondensation, cationically or free-radically,
optionally at least one crosslinking organosilicon compound B,
optionally at least one catalyst or photoinitiator C selected according to a type of reaction envisaged for said polyorganosiloxane A,
optionally at least one adhesion modulator system K, and
optionally at least one crosslinking inhibitor D; and
b) coating said liquid silicone composition X onto a flexible support by a roll coating device,
wherein said preparing further comprises admixing said liquid silicone composition X with an antimisting additive E, wherein said additive E
is in a liquid form, optionally diluted by a diluent J′ or a solvent J″,
has a tangent of a loss angle δ (tan δ), which is a ratio of a viscous modulus (G″) to an elastic modulus (G′), that is >1, and
it is obtainable:
1) by reacting,
at least one organosiloxane monomer, oligomer and/or polymer F having per molecule at least one reactive ≡SiH unit with
at least one organosiloxane monomer, oligomer and/or polymer G exhibiting per molecule at least one reactive ≡SiOH and/or ≡SiR unit, where R is a C₁-C₄₀ carbinol radical, in the presence:
of at least one dehydrocondensation catalyst H, and
of, optionally, at least one crosslinking inhibitor I and/or at least one solvent J,
wherein components F and G are present in an amount so that a ratio of number of reactive ≡SiOH units to number of reactive ≡SiH units≠1:1, and
2) isolating the antimisting additive E, where appropriate after removal of the dehydrocondensation catalyst H and/or devolatilization and/or addition of a crosslinking inhibitor I′.

2. The method, as claimed in claim 1, wherein the antimisting additive E
it is obtainable:
1) by reacting,
at least one organosiloxane monomer, oligomer and/or polymer F having per molecule at least one reactive ≡SiH unit with
at least one organosiloxane monomer, oligomer and/or polymer G exhibiting per molecule at least one reactive ≡SiOH and/or ≡SiR unit, where R is a C₁-C₄₀ carbinol radical, in the presence:
of a dehydrocondensation catalyst H, and
of, optionally, at least one crosslinking inhibitor I,
wherein components F and G are present in an amount such that a ratio of number of reactive ≡SiOH units to number of reactive ≡SiH is <1:1, and
2) isolating the antimisting additive E, where appropriate after removal of the dehydrocondensation catalyst H and/or devolatilization and/or addition of a crosslinking inhibitor I′.

3. The method as claimed in claim 2, wherein the antimisting additive E is of the formula:
MₐD_{b}D′_{c}T_{d}
where:
a, c and d are numbers >than 0,
b≧0
0.5 mol %<c<10 mol %,
0.05 mol %<d<10 mol %,
D′=HR²²SiO_{2/2},
T=R²³SiO_{3/2},
M=R²⁴R²⁵R²⁶SiO_{1/2},
D=R²⁷R²⁸SiO_{2/2};
it being possible for said antimisting additive E to contain up to 10 mol % of residual units DoH and/or TOH where:
D^{OH}=R²⁹R³⁰(OH)SiO_{1/2}, and
T^{OH}=R³¹(OH)SiO_{2/2},
the symbols R²²R²³R²⁴R²⁵R²⁶, R²⁷R²⁸, R²⁹, R³⁰, and R³¹, which are identical or different, represent, each independently of one another:
a linear or branched alkyl radical which contains 1 to 20 carbon atoms and is optionally substituted by at least one halogen,
a cycloalkyl radical which contains between 5 and 8 cyclic carbon atoms and is optionally substituted,
an aryl radical which contains between 6 and 12 carbon atoms and is optionally substituted, and/or
an aralkyl moiety which has an alkyl moiety containing between 5 and 14 carbon atoms and an aryl moiety containing between 6 and 12 carbon atoms and is optionally substituted on the aryl moiety by a halogen and/or an alkyl.

4. The method, as claimed in claim 2, wherein:
the dehydrocondensation catalyst H is a platinum-based metal catalyst, and
a reaction product obtained from said reacting is reacted, with at least one compound of formula CH₂═CHR^{a}, wherein a ratio of number of reactive ≡SiH unit to number of reactive CH₂═CH— units is ≦1:1,
R^{a} being a monovalent radical selected from the group consisting of halogens, hydrogen, a C₁-C₆₀ hydrocarbon radical, a C₁-C₆₀ polyester radical, a C₁-C₆₀ nitrile radical, a C₁-C₆₀ haloalkyl radical, a radical containing one or more silicon atoms, and a C₁-C₆₀ polyether radical.

5. The method, as claimed in claim 1, wherein the antimisting additive E is a branched polyorganosiloxane L or a mixture comprising at least one branched polyorganosiloxane L, said antimisting additive E comprising at least one reactive ≡SiOH and/or ≡SiR unit, with R being a carbinol radical.

6. The method as claimed in claim 1, wherein the dehydrocondensation catalyst H is at least one of a platinum-, rhodium-, palladium-, ruthenium-, boron-, tin- or iridium-based metal catalyst.

7. The method as claimed in claim 1, wherein the organosiloxane monomer, oligomer and/or polymer F having per molecule at least one reactive ≡SiH unit is of the formula:
MᵤDᵥD′_{w}TₓQ_{y}M′_{z}
in which:
u, y, w, x, and z are numbers ≧than/to 0, with w+z>0,
M=R¹R²R³SiO_{1/2},
D=R⁴R⁵SiO_{2/2},
D′=HR⁶SiO_{2/2},
T=R⁷SiO_{3/2},
Q=SiO_{4/2},
M′=HR⁸R⁹SiO_{1/2},
with the symbols R¹, R², R³, R⁴, R⁵, R⁶, R⁷, R⁸, and R⁹, which are identical or different, representing each independently of one another:
a linear or branched alkyl radical which contains 1 to 20 carbon atoms and is optionally substituted by at least one halogen,
a cycloalkyl radical which contains between 5 and 8 cyclic carbon atoms and is optionally substituted,
an aryl radical which contains between 6 and 12 carbon atoms and is optionally substituted, and/or
an aralkyl moiety which has an alkyl moiety containing between 5 and 14 carbon atoms and an aryl moiety containing between 6 and 12 carbon atoms and is optionally substituted on the aryl moiety by a halogen and/or an alkyl.

8. The method as claimed in claim 1, wherein the organosiloxane monomer, oligomer and/or polymer G exhibits per molecule at least one reactive ≡SiOH and/or ≡SiR unit, where R is a carbinol radical, and is selected from the group consisting of the compounds of formulae (I) and (II):
(D^{OH})ᵢDⱼ(T^{OH})ₖTᵣQₘMₙ (I)
Mₒ(D^{R})ₚD_{q}TᵣQₛ(M^{R})ₜ (II)
in which:
i, j, k, l, m, and n are numbers ≧0, with i+k>0,
o, p, q, r, s, and t are numbers ≧0, with p+t>0,
M=R¹⁰R¹¹R¹²SiO_{1/2},
D=R¹³R¹⁴SiO_{2/2},
D^{R}=RR¹⁵SiO_{2/2},
T=R¹⁶SiO_{3/2},
Q=SiO_{4/2},
M^{R}=RR¹⁷R¹⁸SiO_{1/2},
D^{OH}=R¹⁹R²⁰(OH)SiO_{1/2},
T^{OH}=R²¹(OH)SiO_{2/2},
R is a C₁-C₄₀ carbinol group, and
the symbols R¹⁰, R¹¹, R¹², R¹³, R¹⁴, R¹⁵, R¹⁶, R¹⁷, R¹⁸, R¹⁹, R²⁰, and R²¹.
which are identical or different, represent, each independently of one another:
a linear or branched alkyl radical which contains 1 to 20 carbon atoms and is optionally substituted by at least one halogen,
a cycloalkyl radical which contains between 5 and 8 cyclic carbon atoms and is optionally substituted,
an aryl radical which contains between 6 and 12 carbon atoms and is optionally substituted, and/or
an aralkyl moiety which has an alkyl moiety containing between 5 and 14 carbon atoms and an aryl moiety containing between 6 and 12 carbon atoms and is optionally substituted on the aryl moiety by a halogen and/or an alkyl.

9. The method as claimed in claim 1, wherein said liquid silicone composition X, a comprises:
at least one polyorganosiloxane A crosslinkable by polyaddition,
at least one crosslinking organosilicon compound B,
at least one catalyst C1 of a polyaddition reaction,
optionally at least one adhesion modulator system K, and
optionally at least one crosslinking inhibitor D.

10. The method as claimed in claim 9, wherein the polyorganosiloxane A crosslinkable by polyaddition exhibits units of the formula (III) and optionally at least some of other units are units of formula (IV):
$$\begin{matrix}{W}_{a} {Z}_{b} SiO \frac{4 - ( a + b )}{2} & ( III ) \\ {Z}_{c} SiO \frac{4 - c}{2} & ( IV )\end{matrix}$$
wherein:
W is an alkenyl group,
the symbols Z, which are identical or different, represent:
a linear or branched alkyl radical which contains 1 to 20 carbon atoms and is optionally substituted by at least one halogen,
a cycloalkyl radical which contains between 5 and 8 cyclic carbon atoms and is optionally substituted,
an aryl radical which contains between 6 and 12 carbon atoms and is optionally substituted, and/or
an aralkyl moiety which has an alkyl moiety containing between 5 and 14 carbon atoms and an aryl moiety containing between 6 and 12 carbon atoms and is optionally substituted on the aryl moiety by a halogen and/or a alkyl,
a is 1 or 2, b is 0, 1 or 2, and a+b=1, 2 or 3, and
c=0, 1, 2 or 3.

11. The method as claimed in claim 9, wherein the crosslinking organosilicon compound B exhibits units of formula (V) and optionally at least some of the other units are units of formula (VI):
HL_{c}SiO_{(3-c)/2} (V)
L_{g}SiO_{(4-g)/2} (VI)
in which:
the symbols L, which are identical or different, represent:
a linear or branched alkyl radical which contains 1 to 20 carbon atoms and is optionally substituted by at least one halogen,
a cycloalkyl radical which contains between 5 and 8 cyclic carbon atoms and is optionally substituted,
an aryl radical which contains between 6 and 12 carbon atoms and is optionally substituted, and/or
an aralkyl moiety which has an alkyl moiety containing between 5 and 14 carbon atoms and an aryl moiety containing between 6 and 12 carbon atoms and is optionally substituted on the aryl moiety by a halogen and/or a alkyl,
c=0, 1 or 2, and
g=0, 1, 2 or 3.

12. A branched polyorganosiloxane L′, or a mixture comprising at least one branched polyorganosiloxane L′, that is:
in a liquid form,
has a tangent of a loss angle δ (tan δ) of said branched which is a ratio of a viscous modulus (G″) to a elastic modulus (G′), is >1, and
is obtainable by:
1) by reacting,
at least one organosiloxane monomer, oligomer and/or polymer F having per molecule at least one reactive ≡SiH unit with
at least one organosiloxane monomer, oligomer and/or polymer G exhibiting per molecule at least one reactive ≡SiOH and/or ≡SiR unit, where R is a C₁-C₄₀ carbinol radical, in the presence:
of a dehydrocondensation catalyst H which is a platinum-based metal catalyst, and
of, optionally, at least one crosslinking inhibitor I,
wherein components F and G are present in an amount such that a ratio of number of reactive ≡SiOH units to number of reactive ≡SiH from 1:3 to 1:50, and
2) isolating said polyorganosiloxane L′ where appropriate after removal of the dehydrocondensation catalyst H and/or devolatilization and/or addition of a crosslinking inhibitor I′.

13. The branched polyorganosiloxane L′ or a mixture comprising at least one branched polyorganosiloxane L′, as claimed in claim 12, wherein:
the dehydrocondensation catalyst H is a platinum-based metal catalyst, and
after said reacting a reaction product is reacted, with at least one compound of formula CH₂═CHR^{a}, wherein a ratio of reactive ≡SiH units to reactive CH₂═CH— units is ≦1:1,
R^{a} being a monovalent radical selected from the group consisting of halogens, hydrogen, a C₁-C₆₀ hydrocarbon radical, a C₁-C₆₀ polyester radical, a C₁-C₆₀ nitrile radical, a C₁-C₆₀ haloalkyl radical, a radical containing one or more silicon atoms, and a C₁-C₆₀ polyether radical.

14. The branched polyorganosiloxane L′ or a mixture comprising at least one branched polyorganosiloxane L′, as claimed in claim 12, which of the formula:
MₐD_{b}D′_{c}T_{d}
where:
a, c and d are numbers >0,
b≧0,
0.5 mol %<c<10 mol %,
0.05 mol %<d<9 mol %,
D′=HR²²SiO_{2/2},
T=R²³SiO_{3/2},
M=R²⁴R²⁵R²⁶SiO_{1/2},
D=R²⁷R²⁸SiO_{2/2};
it being possible for said branched polyorganosiloxane L′ to contain up to 10 mol % of residual units D^{OH} and/or T^{OH} where:
D^{OH}=R²⁹R³⁰(OH)SiO_{1/2}, and
T^{OH}═R³¹(OH)SiO_{2/2},
the symbols R²², R²³, R²⁴, R²⁵, R²⁶, R²⁷, R²⁸, R²⁹, R³⁰, and R³¹, which are identical or different, represent, each independently of one another:
a linear or branched alkyl radical which contains 1 to 20 carbon atoms and is optionally substituted by at least one halogen,
a cycloalkyl radical which contains between 5 and 8 cyclic carbon atoms and is optionally substituted,
an aryl radical which contains between 6 and 12 carbon atoms and is optionally substituted, and/or
an aralkyl moiety which has an alkyl moiety containing between 5 and 14 carbon atoms and an aryl moiety containing between 6 and 12 carbon atoms and is optionally substituted on the aryl moiety by a halogen and/or an alkyl.

15. A branched polyorganosiloxane L″ or a mixture comprising at least one branched polyorganosiloxane L″, wherein:
said branched polyorganosiloxane L″ contains at least one reactive ≡SiOH and/or ≡SiR unit, where R is a carbinol radical,
said polyorganosiloxane L″ is present in a liquid form, optionally diluted by a diluent J′ or a solvent J″,
a tangent of a loss angle δ (tan δ) of said branched polyorganosiloxane L″ or of the mixture comprising at least said branched polyorganosiloxane L″, which is the ratio of the viscous modulus (G″) to the elastic modulus (G′), is >1, and
L″ being obtainable by:
1) reacting:
at least one organosiloxane monomer, oligomer and/or polymer F having per molecule at least one reactive ≡SiH unit with
at least one organosiloxane monomer, oligomer and/or polymer G exhibiting per molecule at least one reactive ≡SiOH and/or ≡SiR unit,
where R is a C₁-C₄₀ carbinol radical, in the presence:
of a dehydrocondensation catalyst H, and
of, optionally, at least one crosslinking inhibitor I and/or at least one solvent J,
wherein components F and G are present in an amount such that a ratio of number of reactive ≡SiOH units to number of reactive ≡SiH is <1:1, and
2) isolating said polyorganosiloxane L″, where appropriate after removal of the dehydrocondensation catalyst H and/or devolatilization and/or addition of a crosslinking inhibitor I′.

16. A liquid silicone composition X which is, a precursor of a silicone coating said composition, comprising:
at least one polyorganosiloxane A crosslinkable by polyaddition, by dehydrocondensation, by polycondensation, cationically or free-radically, and/or at least one adhesion modulator system K, and/or at least one crosslinking inhibitor D, and/or at least one crosslinking organosilicon compound B, and/or at least one catalyst or photoinitiator C selected according to a type of reaction envisaged for said polyorganosiloxane A, and
at least one antimisting additive E.

17. An antimisting additive E comprising a branched polyorganosiloxane L′ of claim 12 that is capable of to reducing misting when coating a flexible support with a liquid silicone composition X which is a precursor of a silicone coating.
